(19) United States
(12) Patent Application Publication
(10) Pub. No.: US 2013/0063996 A1
(43) Pub. Date: Mar. 14, 2013

(54) POWER SUPPLY APPARATUS

(71) Applicant: Hiroshi NAKAO, Yamato (JP)

(72) Inventor: Hiroshi NAKAO, Yamato (JP)

(73) Assignee: FUJITSU LIMITED, Kawasaki-shi (JP)

(21) Appl. No.: 13/594,055

(22) Filed: Aug. 24, 2012

(30) Foreign Application Priority Data
Sep. 13, 2011 (JP) 2011-199858

(51) Int. Cl. H02M 7/217

(52) U.S. Cl. 363/127

(57) ABSTRACT

A power supply apparatus includes: an input terminal to which alternating current power is input; a positive terminal and a negative terminal at which direct-current power is output; a rectifier circuit configured to rectify the alternating current power input to the input terminal; an inductor coupled to the rectifier circuit; a capacitor coupled between the positive terminal and the negative terminal; a first rectifying element coupled between an output terminal of the inductor and the positive terminal; a first switching element coupled between an input terminal of the first rectifying element and the negative terminal; a second switching element and a transformer coupled in parallel to the first switching element; a second rectifying element coupled between the positive terminal and a coupling portion of the second switching element and the transformer; and a third rectifying element coupled between the transformer and the positive terminal.

### CROSS-REFERENCE TO RELATED APPLICATION

This application is based upon and claims the benefit of priority of the prior Japanese Patent Application No. 2011-199858, filed on Sep. 13, 2011, the entire contents of which are incorporated herein by reference.

### FIELD

The embodiments discussed herein are related to a power supply apparatus.

### BACKGROUND

In recent years, conservation of energy resources has been attracting attention in various fields. Its influence has extended to, for example, the field of power supplies. Specifically, for example, a demand for higher efficiency of switching power supplies is increasing.

Currently, switching power supplies whose output power efficiencies exceed 90% are already proposed. Some of them use a technique to increase output power efficiency, so that a power factor correction (PFC) circuit for improving the power factor is provided in the switching power supply.

FIG. 1 is an example circuit diagram of a power supply apparatus having a PFC circuit.

The power supply apparatus illustrated in FIG. 1 includes a rectifier circuit 10, a PFC circuit 20, controller 50, and a direct current (DC)-DC converter 60.

The rectifier circuit 10 is a diode bridge that is made up of four diodes 11, 12, 13, and 14 coupled in a bridge configuration. The rectifier circuit 10, which is coupled to an alternating current power supply 1, performs full-wave rectification of alternating current power and outputs the result. Here, the output voltage of the alternating current power supply 1 is Vin, and therefore the input voltage of the rectifier circuit 10 is Vin. The rectifier circuit 10 outputs electric power obtained by full-wave rectification of alternating current power input from the alternating current power supply 1.

Alternating current power having a voltage of 80 V to 265 V, for example, is input to the rectifier circuit 10, and therefore voltage drops of the diodes 11, 12, 13, and 14 of the rectifier circuit 10 may be disregarded. As a result, the output voltage of the rectifier circuit 10 is also Vin.

The PFC circuit 20 includes an inductor 21, a switching element 22, and a diode 23, which are coupled in a T-shape configuration, and a smoothing capacitor 40. The PFC circuit 20 is an active filter circuit that reduces distortion of harmonics and the like included in a current rectified in the rectifier circuit 10, thereby improving the power factor of electric power.

A boost inductor, for example, is used as the inductor 21, and a metal oxide semiconductor field-effect transistor (MOSFET), for example, is used as the switching element 22. On/off operations of the switching element 22 are performed by application of a pulsed gate voltage from the controller 50 to the gate of the switching element 22, so that pulse width modulation (PWM) driving of the switching element 22 is performed.

The diode 23 may have a rectification direction from the inductor 21 toward the smoothing capacitor 40, and a fast recovery diode, or a SiC Schottky diode, for example, is used as the diode 23.

The controller 50 outputs a pulsed gate voltage to be applied to the gate of the switching element 22. The controller 50 determines the duty ratio of the gate voltage based on the voltage value Vin of full-wave rectified power output from the rectifier circuit 10, a current value IQ of a current flowing through the switching element 22, and a voltage value Vout on the output side of the smoothing capacitor 40, and applies the duty ratio to the gate of the switching element 22. A multiplier circuit that may calculate the duty ratio based on the current value IQ and the voltage values Vout and Vin, for example, may be used as the controller 50.

The smoothing capacitor 40 performs smoothing of a voltage to be output from the PFC circuit 20 and then inputs it to the DC-DC converter 60. A forward or full-bridge DC-DC converter, for example, may be used as the DC-DC converter 60. For example, direct-current power having a voltage of 385 V is input to the DC-DC converter 60.

The DC-DC converter 60 is a conversion circuit that converts the voltage value of direct-current power and outputs the converted direct-current power, and a load circuit 70 is coupled to the output side thereof.

Here, the DC-DC converter 60 converts direct-current power having a voltage of 385 V into a direct-current power having a voltage of 12 V, for example, and outputs the result to the load circuit 70.

With reference to FIG. 2A and FIG. 2B, operations of the PFC circuit 20 will be described next.

FIG. 2A illustrates waveforms of an input voltage Vin and an input current Iin of the rectifier circuit 10 in the case where there is no PFC circuit. FIG. 2B illustrates waveforms of the input voltage Vin and the input current Iin of the rectifier circuit 10 in the case where the PFC circuit 20 is provided. In FIG. 2A and FIG. 2B, the input voltage Vin is indicated by a solid line, and the input current Iin is indicated by a dashed line. As indicated by a solid line in FIG. 2A or FIG. 2B, an alternating voltage in the shape of a sine wave is input as the input voltage Vin to the rectifier circuit 10 of the power supply apparatus.

A load circuit of a power supply apparatus is typically not a simple resistor but includes various circuits. Therefore, in the case where there is provided no PFC circuit as illustrated in FIG. 2A, the input current Iin flows only when the input voltage Vin exceeds a voltage across the smoothing capacitor 40, and therefore the duration in which the input current Iin flows is short and the peak value of the input current Iin is high, that is, a harmonic current appears.

In contrast, as illustrated in FIG. 2B, in the case where there is provided a PFC circuit, the switching element 22 in the PFC circuit 20 is turned on or off in accordance with the voltage value across an input terminal of the load circuit 70, so that a current in the shape of a sine wave is produced. In this way, a PFC circuit has an action of improving the power factor by lowering and extending the wave of the input current Iin to produce an alternating current in the shape of a sine wave.

The following is reference document:

### [Document 1] Japanese Laid-open Patent Publication No. 2005-253284

### SUMMARY

According to an aspect of the invention, a power supply apparatus includes: an input terminal to which alternating current power is input; a positive terminal and a negative terminal at which direct-current power is output; a rectifier circuit configured to rectify the alternating current power input to the input terminal; an inductor coupled to the rectifier circuit; a capacitor coupled between the positive terminal and the negative terminal; a first rectifying element coupled between an output terminal of the inductor and the positive terminal, the first rectifying element having a rectifying direction from the output terminal of the inductor toward the positive terminal; a first switching element coupled between an input terminal of the first rectifying element and the negative terminal; a second switching element and a transformer coupled in parallel to the first switching element; a second rectifying element coupled between the positive terminal and a coupling portion of the second switching element and the transformer, the second rectifying element having a rectification direction from the coupling portion toward the positive terminal; and a third rectifying element coupled between the transformer and the positive terminal, the third rectifying element having a rectifying direction from the transformer toward the positive terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a circuit diagram illustrating an example power supply apparatus having a PFC circuit;

FIG. 2A and FIG. 2B are diagrams for explaining operations of the PFC circuit;

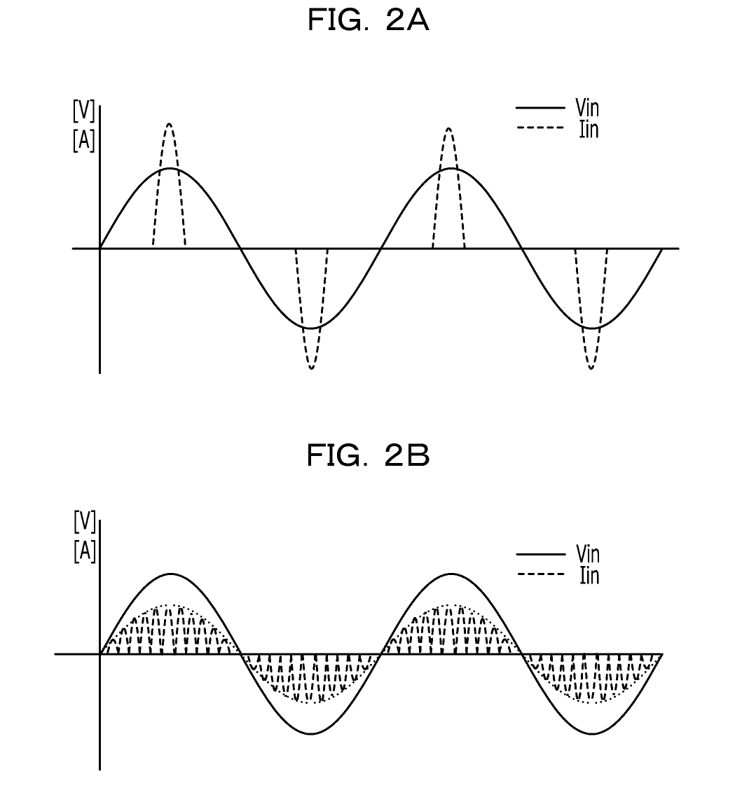

FIG. 3A and FIG. 3B are cross-sectional views of GaN-HEMTs;

FIG. 4A and FIG. 4B are diagrams for explaining an element loss;

FIG. 5 is a circuit diagram of a power supply apparatus of a first embodiment;

FIG. 6A to FIG. 6G are diagrams for explaining operations of the PFC circuit of the first embodiment;

FIG. 7 is a graph for explaining effects of the power supply apparatus of the first embodiment;

FIG. 8 is a graph for explaining effects of the power supply apparatus of the first embodiment; and

FIG. 9 is a circuit diagram of a power supply apparatus of a second embodiment.

### DESCRIPTION OF EMBODIMENTS

In order to further improve the power efficiency of a power supply apparatus, it is desirable, for example, to decrease power consumed in a switching element (a transistor for switching) for use in the power supply apparatus. The causes of power consumption in the transistor for switching are considered as follows. One cause is a resistance component between the source and drain of the transistor when the transistor is on, which is termed “on-resistance”. The other cause is a loss that is generated in the transient state when the transistor switches between its on and off states. This is a so-called switching loss.

The problem resulting from on-resistance of a transistor arises during the on-state of the transistor. That is, regarding on-resistance of a transistor, when a current is caused to flow through the transistor under the condition where the transistor is on, a voltage between the transistor's terminals through which the current flows is generated by the on-resistance and the current, owing to Ohm's law.

Here, power consumed by the transistor is the product of a current flowing through the transistor and a voltage generated between both the terminals through which the current flows in the transistor. The power is therefore not extracted as an output of switching power supply but is converted into heat by the transistor and thus results in a power loss.

Next, regarding a loss that arises in the transient state between on and off states of the transistor, which is referred as a switching loss, the reason why the loss arises is that there is a time called a switching time during which neither current nor voltage is zero. Given that the change of the current and voltage in the transient state is approximately a function of time, the switching loss may be expressed as follows: current X voltage X switching time/2. Accordingly, in order to decrease the switching loss, the drive capacity of a transistor has to be increased, that is, the switching speed has to be increased.

Thus, in order to reduce the power loss described above, it is desirable to use a switching element that is small in on-resistance and high in switching speed. A transistor that is used for a switching power supply and satisfies both characteristics is developed. This transistor uses a compound semiconductor material, but not silicon. That is, in many of compound semiconductors, electron mobility is high and mutual conductance is high, compared to silicon. The on-resistance may therefore be decreased, and capacities that appear between each terminal of the transistor are small.

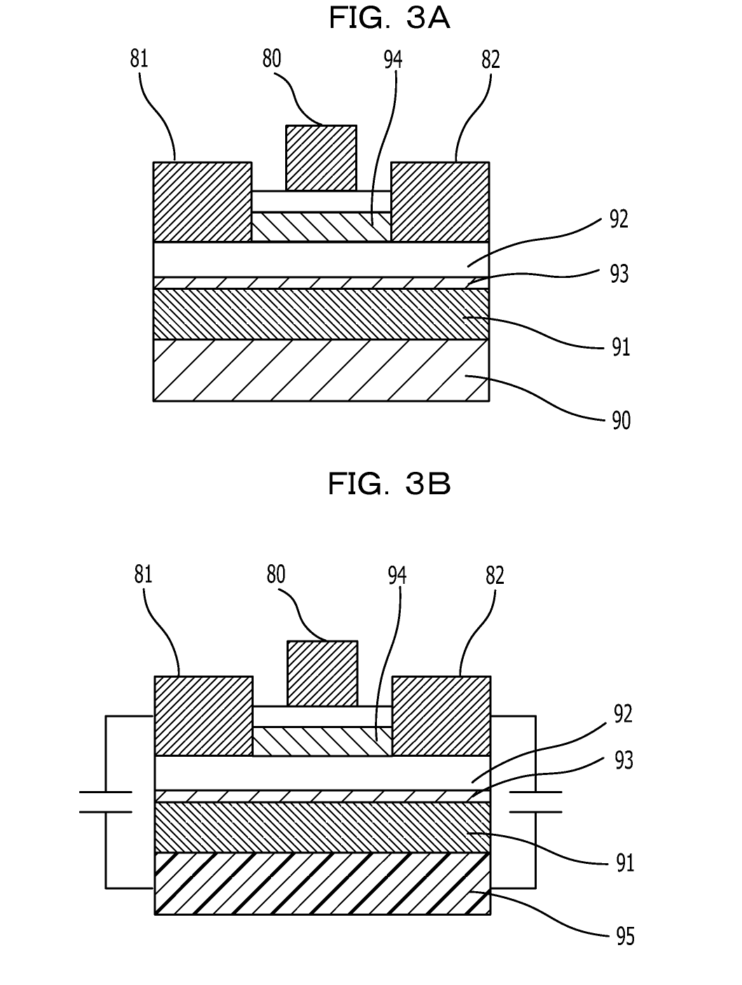

With reference to FIG. 3A and FIG. 3B, a high electron mobility transistor (HEMT) using gallium nitride (GaN) will next be described as an example of a compound semiconductor. Hereinafter, this transistor is referred to as a GaN-HEMT.

A GaN-HEMT is a three-terminal transistor having the drain, the source, and the gate. For example, when the source is grounded, a given positive voltage is applied between the source and the drain, and a voltage applied between the source and the gate is made to be equal to or greater than a threshold, conduction is established between the source and the drain (turning on). The threshold of a voltage applied between the source and the gate is in a range from −10 V to +10 V, for example. GaN-HEMTs together with their operations may be handled like MOSFETs.

FIG. 3A illustrates a cross-section of a GaN-HEMT. In the GaN-HEMT, a GaN layer 91 and a AlGaN layer 92 are provided by crystal growth on a substrate 90 of, for example, sapphire, SiC, GaN, or Si, and a source 81 and a drain 82 with a n-GaN layer 94 sandwiched there between are formed on the AlGaN layer 92. A gate 80 is formed above the n-GaN layer 94. In the GaN-HEMT, a two-dimensional electron gas layer 93 between the GaN layer 91 and the AlGaN layer 92 is used as the electron transit layer.

In order to manufacture a high-speed operating GaN device, it is desirable to use a semi-insulating SiC substrate as the substrate for restricting a parasitic capacitance. Unfortunately, the prices of semi-insulating single crystal SiC substrates are very high, and conductive Si substrates, which may be obtained at low prices, are used for GaN-HEMTs of general purpose applications.

FIG. 3B is a cross-sectional view of a GaN-HEMT using a conductive Si substrate 95 as its substrate. If a semiconductor device is produced on the conductive Si substrate 95, the source 81 and the drain 82 are parasitically coupled to form a parasitic capacitance.

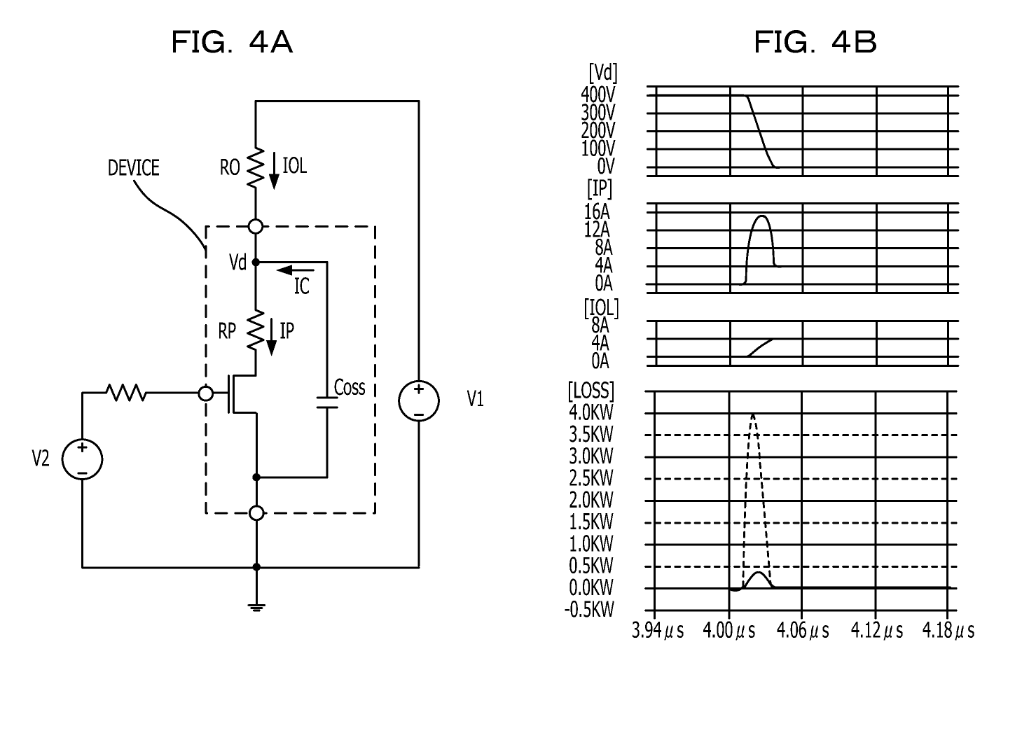

FIG. 4A and FIG. 4B are diagrams for explaining an element loss of a switching element having a parasitic capacitance between the source and the drain. FIG. 4A is a circuit diagram for performing a simulation of an element loss of the switching element. FIG. 4B illustrates the result of the simulation of the current, voltage, and loss of the switching element in the simulation circuit diagram of FIG. 4A.

When a given positive voltage V1 is applied between the source and the drain of the switching element, and a voltage V2 applied between the source and the gate is made to be equal to or greater than a threshold, conduction is established between the source and the drain. In the simulation, a parasitic capacitance Coss of 600 pF is set between the source and the drain, and a wiring resistance RP of 0.01 Ω is set on the drain side.

When the voltage V2 applied between the source and the gate is caused to be equal to or greater than the threshold, conduction is established between the source and the drain (turning on). At this point, only a current IOL of about 4 A flows through a load resistor RO external to the switching element. However, a current IP of as much as about 15 A, which includes a discharge current IC of charges accumulated in the load capacity Coss, flows between the drain and the source of the switching element. Consequently, the loss expressed as the product of voltage and current momentarily reaches as much as 4.0 kW.

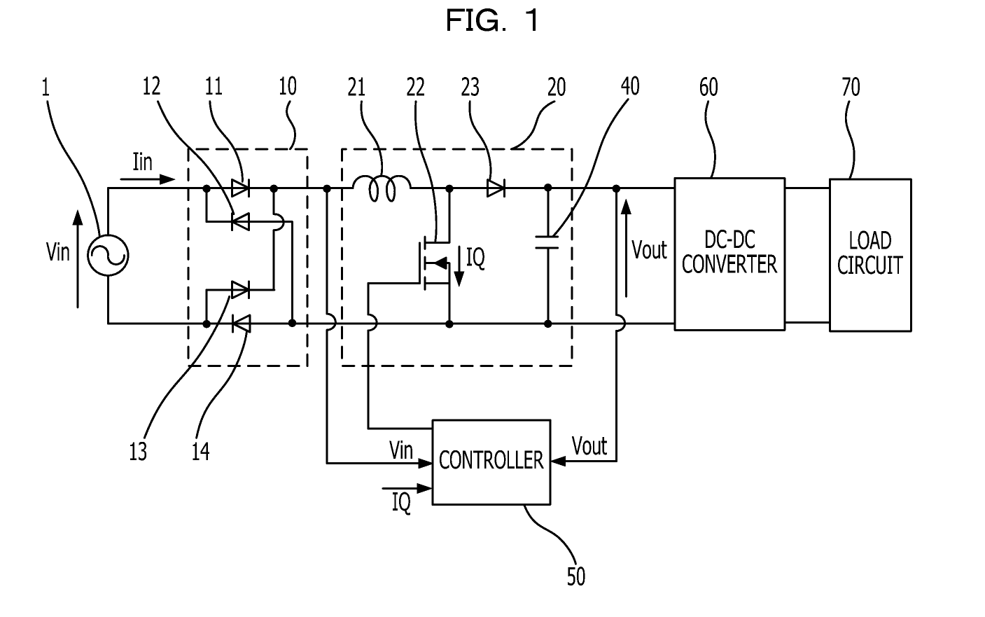

As such, replacing the switching element 22 in the PFC circuit 20 of the power supply apparatus illustrated in FIG. 1 with a switching element having a large parasitic capacitance between the source and the drain thereof, such as a GaN-HEMT having the parasitic capacitance between the source and the drain illustrated in FIG. 3B actually results in an increase in power loss.

Preferred embodiments related to the technology disclosed herein will be described in detail below with reference to the drawings.

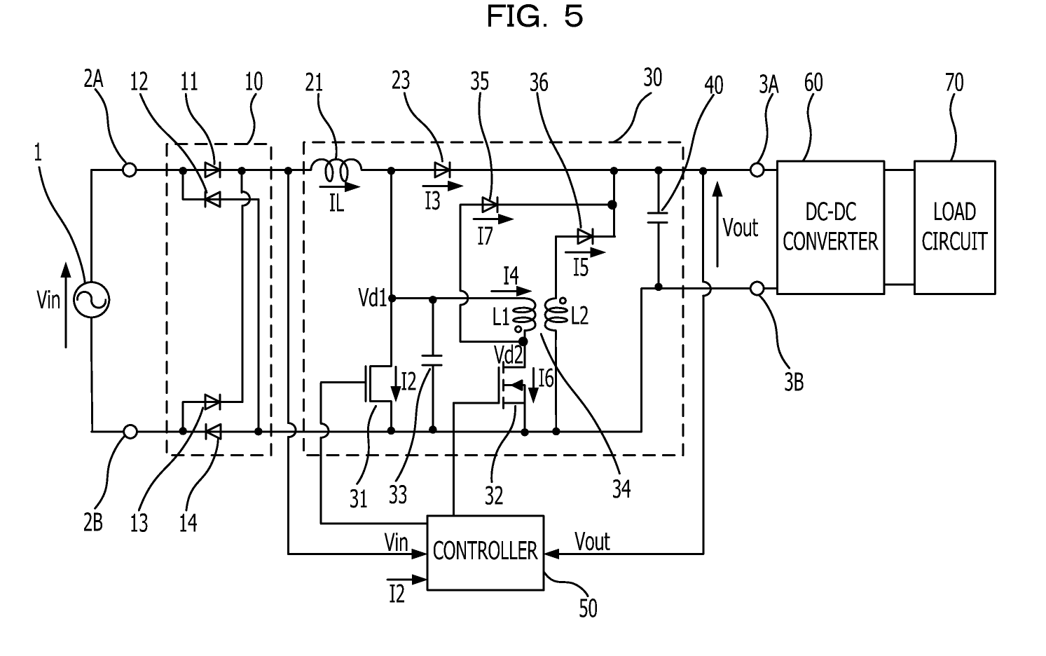

FIG. 5 is a circuit diagram illustrating a power supply apparatus of a first embodiment to which the technology disclosed herein is applied. In FIG. 5, identical or equivalent elements to those of the power supply apparatus illustrated in FIG. 1 are denoted by identical reference characters, and descriptions thereof are omitted.

The power supply apparatus includes input terminals 2A and 2B, the rectifier circuit 10, a PFC circuit 30, the controller 50, output terminals 3A and 3B, and the DC-DC converter 60.

Alternating current power is input from the alternating current power supply 1 to the input terminals 2A and 2B.

The output terminal 3A is a positive terminal at which direct-current power is output, and the output terminal 3B is a negative terminal at which direct-current power is output. The output terminals 3A and 3B are coupled to the input side of the DC-DC converter 60, and the DC-DC converter 60 converts direct-current power having a voltage of 385 V into a direct-current power having a voltage of 12 V, for example, and outputs the result to the load circuit 70.

The PFC circuit 30 includes the inductor 21, the first diode 23, and a main switching element 31, which are coupled in a T-shape configuration. Primary winding L1 of a flyback transformer 34 and a sub switching element 32 coupled in series are coupled in parallel to the main switching element 31. A smoothing capacitor 33 is coupled in parallel to the main switching element 31.

A second diode 35 having a rectification direction toward the smoothing capacitor 40 is coupled to a coupling portion where the sub switching element 32 and the primary winding L1 of the flyback transformer 34 are coupled, and a third diode 36 having a rectification direction toward the smoothing capacitor 40 is coupled to the side of secondary winding L2 of the flyback transformer 34.

A GaN-HEMT is used as the main switching element 31 in this embodiment. An HEMT made of GaN (gallium nitride) has characteristics that this HEMT may operate at higher speeds and has a smaller on-resistance than a MOSFET made of silicon.

A GaN-HEMT is a three-terminal transistor having the drain, the source, and the gate. For example, when the source is grounded, a given positive voltage is applied between the source and the drain, and a voltage applied between the source and the gate is made to be equal to or greater than a threshold, conduction is established between the source and the drain (turning on). The threshold of a voltage applied between the source and the gate is in a range from −10 V to +10 V, for example. GaN-HEMTs together with their operations may be handled like MOSFETs.

The main switching element 31 is turned on or off by application of a pulsed gate voltage from the controller 50 to the gate of the main switching element 31, so that pulse width modulation (PWM) driving of the main switching element 31 is performed.

The controller 50 determines the duty ratio of the gate voltage based on the voltage value Vin of full-wave rectified power output from the rectifier circuit 10, a current value I2 of a current flowing in the main switching element 31, and the voltage value Vout on the output side of the smoothing capacitor 40, and applies the duty ratio to the gate of the main switching element 31.

The flyback transformer 34 and the sub switching element 32 coupled in parallel to the main switching element 31 have actions of suppressing a surge current that is generated when the main switching element 31 is turned on, and decreasing the switching loss in the main switching element 31.

Here, a drain-source current flowing in the main switching element 31 is denoted by I2, a current flowing through the diode 23 is denoted by I3, a current flowing through the primary winding L1 of the flyback transformer 34 is denoted by I4, a regenerative current flowing on the side of the secondary winding L2 of the flyback transformer 34 is denoted by I5, a drain-source current flowing in the sub switching element 32 is denoted by I6, and a regenerative current flowing from the second diode 35 to the smoothing capacitor 40 is denoted by I7.

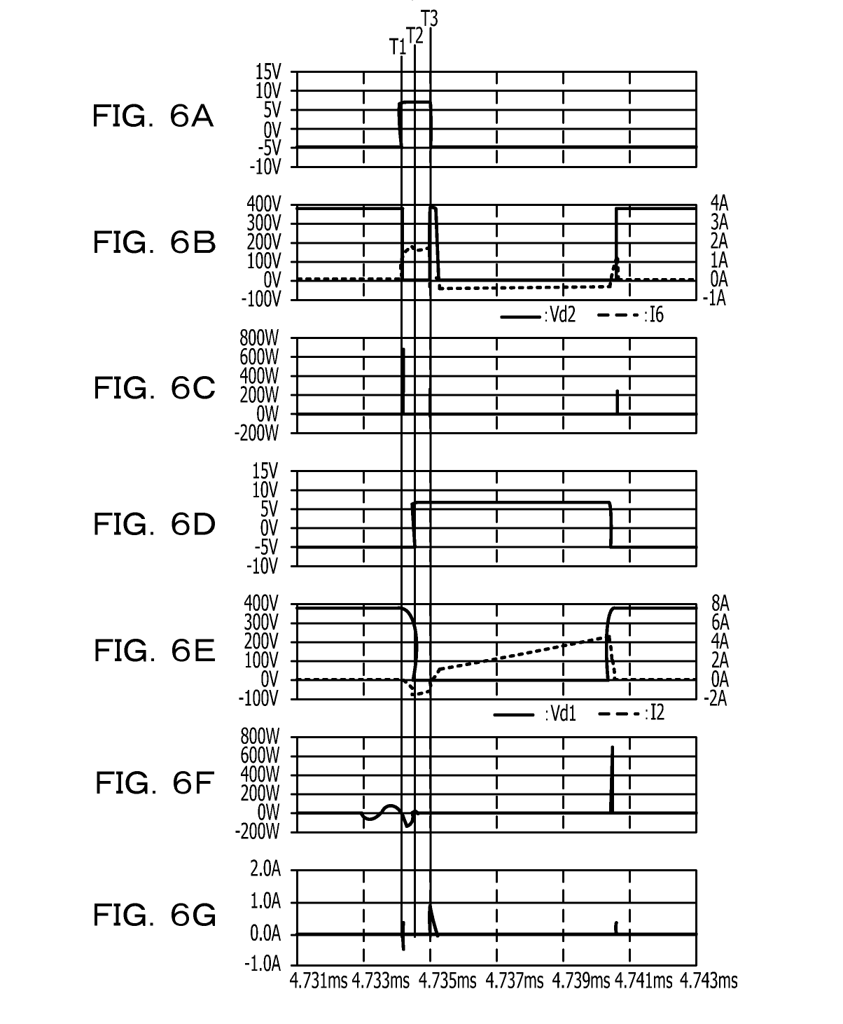

FIG. 6A to FIG. 6G illustrate waveforms for explaining operations of the main switching element 31 and the sub switching element 32 of the power supply apparatus of this embodiment.

FIG. 6A illustrates a gate signal of the sub switching element 32, FIG. 6B illustrates a drain voltage Vd2 and the drain-source current I6 of the sub switching element 32, and FIG. 6C illustrates a switching loss in the sub switching element 32. FIG. 6D illustrates a gate signal of the main switching element 31, FIG. 6E illustrates a drain voltage Vd1 and the drain-source current I2 of the main switching element 31, and FIG. 6F illustrates a switching loss in the main switching element 31. FIG. 6G illustrates the regenerative current I5 flowing from the flyback transformer 34 to the third diode 36.

In FIG. 6A, the gate signal of the sub switching element 32 is turned on at a timing T1 by the controller 50 before the main switching element 31 is turned on.

With reference back to FIG. 5, when the sub switching element 32 is turned on, a current flows from the inductor 21 through the primary winding L1 of the flyback transformer 34 to the sub switching element 32, and thus the current I4 and I6 will flow.

During the on state of the sub switching element 32, the current 14 flowing through the primary winding L1 of the flyback transformer 34 does not flow into the diode 35. Instead, all the current I4 flows into the sub switching element 32, and, as a result, the value of the current I4 flowing through the primary winding L1 of the flyback transformer 34 and the value of the current I6 flowing between the drain and source of the sub switching element 32 become equal. With reference to FIG. 6E, the drain voltage Vd1 of the main switching element 31 becomes zero.

Even when the gate signal of the main switching element 31 is turned on at a timing T2, the sub switching element 32 still remains in the on state. As a result, as illustrated in FIG. 6E, the drain-source current I2 does not flow through the main switching element 31.

With reference to FIG. 6F, since the drain voltage Vd1 is zero at the time point T2, the loss expressed as the product of voltage and current is also zero. As a result, the element loss in the main switching element 31 disappears.

With reference to FIG. 6B, when the gate signal of the main switching element 31 is turned on and then the gate signal of the sub switching element 32 is turned off at a timing T3, the current 16 flowing through the sub switching element 32 becomes 0 A.

With reference to FIG. 6E, after that, the current 12 flowing through the main switching element 31 increases gradually.

The core of flyback transformer 34 is magnetized by the current 14 flowing through the primary winding L1 of the flyback transformer 34 during the on state of the sub switching element 32. When the sub switching element 32 is turned off, the current I4 will not flow into the primary winding L1 of the flyback transformer 34. At this time, the regeneration current I5 flows into the secondary winding L2 of the flyback transformer 34 in a direction for negating the magnetic field that has occurred in the primary side of the flyback transformer 34. The regenerative current I5 is regenerated through the third diode 36 to the smoothing capacitor 40. For this reason, as illustrated in FIG. 6G, the regenerative current 15 starts flowing immediately after the timing T3 at which the sub switching element 32 is turned off, and the value of the regenerative current I5 approaches 0 A as the magnetization of the core becomes weaker.

Immediately after the sub switching element 32 is turned off, energy accumulated in a leakage inductance of the flyback transformer 34 is also regenerated to the smoothing capacitor 40 by the current I7 flowing through the second diode 35.

If the second diode 35 does not exist, the energy accumulated in the leakage inductance of the flyback transformer 34 causes a large surge voltage to be generated immediately after the sub switching element 32 is turned off. There is a possibility that the surge voltage may break the sub switching element 32. Therefore, the sub switching element 32 has to be made as a transistor having a higher withstand voltage.

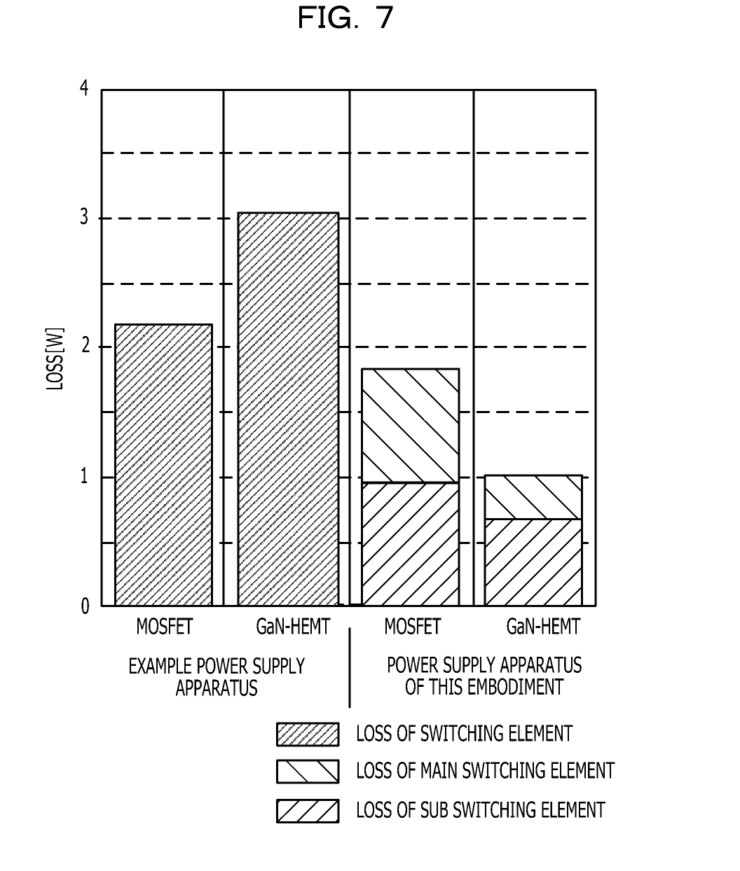

Subsequently, with reference to FIG. 7, the loss effects of the switching elements in the power supply apparatus of the first embodiment will be described. FIG. 7 illustrates simulation results of element losses in cases where switching elements are MOSFETs and in cases where switching elements are GaN- HEMTs both in an example power supply apparatus and the power supply apparatus of this embodiment. Under conditions where Vin is 100 VAC, Vout is 380 VDC, and output is 150 W, simulations of losses of the power supply apparatuses are performed.

The leftmost bar represents an element loss in the case where the switching element is a MOSFET in the example power supply apparatus, the second bar from the left represents an element loss in the case where the MOSFET is changed to a GaN-HEMT in the example power supply apparatus, the third bar from the left represents the sum of element losses of the first and second switching elements in the case where the main switching element 31 is a MOSFET in the power supply apparatus of the first embodiment, and the rightmost bar represents the sum of element losses of the first and second switching elements in the case where the main switching element 31 is a GaN-HEMT in the power supply apparatus of the first embodiment.

When the leftmost bar and the second bar from the left in the graph of simulation results are compared, it is found that only replacing a MOSFET in a PFC circuit with a GaN-HEMT actually results in an increase in power loss since the GaN-HEMT has a parasitic capacitance, as described above.

From the simulation results, it is found that the total loss of the switching elements in the PFC circuit of the power supply apparatus of this embodiment, which is represented by the rightmost bar, is about a half of the loss of the switching element of the example power supply apparatus using a MOSFET, which is represented by the leftmost bar. It is also found that there is some effect in the case where a MOSFET is still used and a GaN-HEMT is not used as the switching element, in the power supply apparatus of this embodiment, which is represented by the second bar from the right.

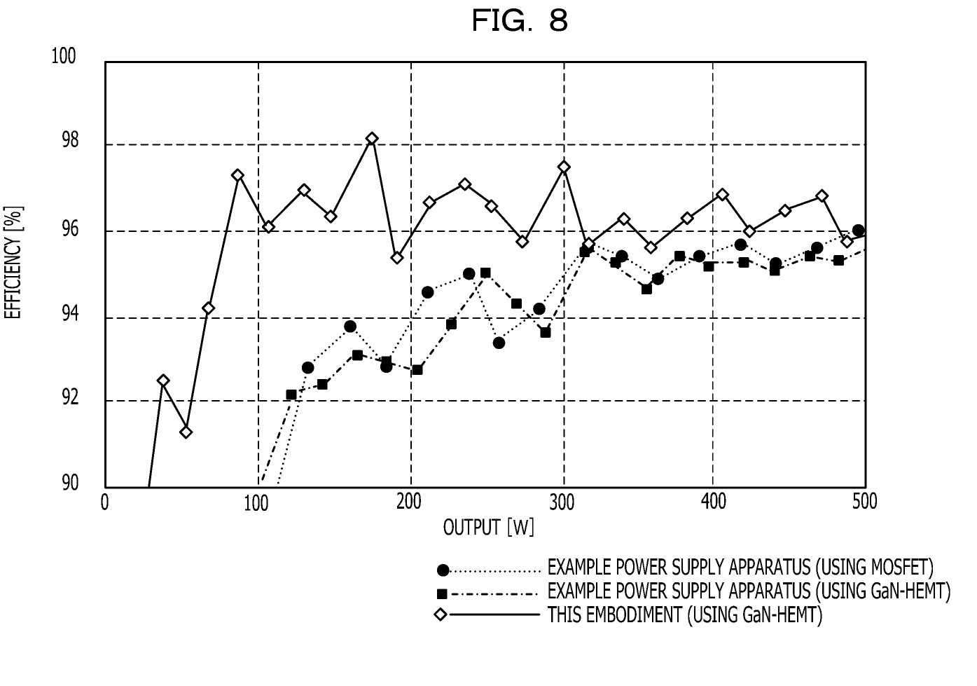

Subsequently, with reference to FIG. 8, the efficiency of the PFC circuit in the power supply apparatus of this embodiment will be described. FIG. 8 illustrates experimental results obtained by measuring PFC efficiencies in PFC circuits of the example power supply apparatus and the PFC circuit of the power supply apparatus of this embodiment.

Under experimental conditions where Vin is 200 VAC, Vout is 380 VDC, and the switching frequency is 100 kHz, the efficiencies of PFC circuits of power supply apparatuses are measured.

As illustrated in FIG. 8, the efficiencies of PFC circuits in the example power supply apparatus are 90% or less in cases where the load is low and the output is 100 W or less. As for the efficiency of the PFC circuit in the power supply apparatus of this embodiment, however, the efficiency improves from 90% to 98%. The element losses are invariant independently of output power, and it is therefore found that the efficiencies remarkably improve on the low output side.

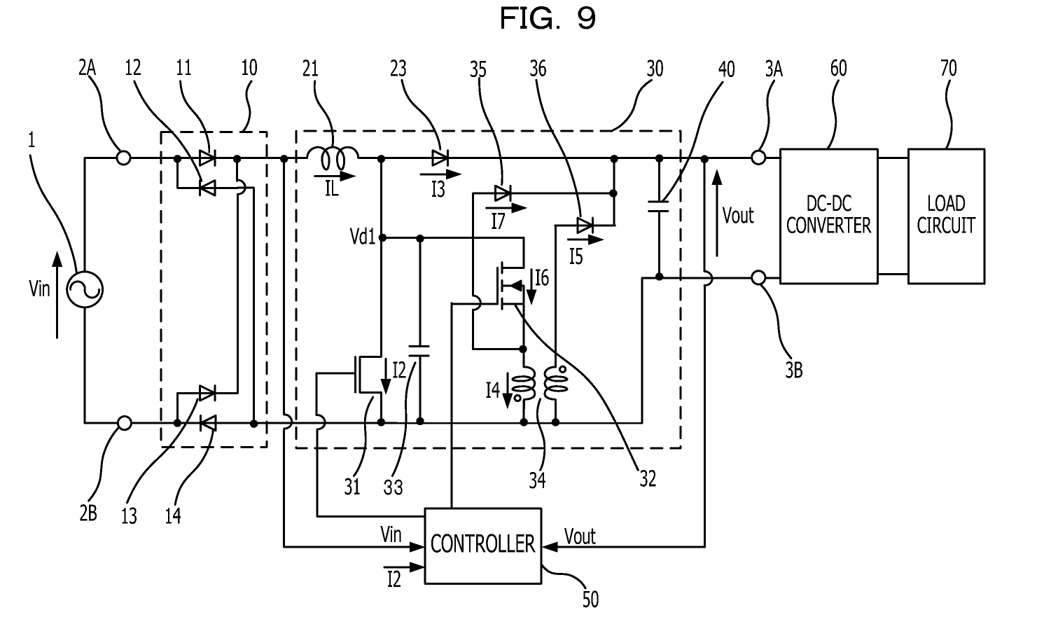

FIG. 9 is a circuit diagram of a power supply apparatus of a second embodiment.

In the power supply apparatus of the second embodiment, the position of the sub switching element 32 coupled in parallel to the main switching element 31 and the position of the flyback transformer 34 in the PFC circuit 30 of the first embodiment are swapped.

As illustrated in FIG. 6G, in the first embodiment, a current flows through the diode 35 into the flyback transformer 34 when the main switching element 31 is off. This current increases with an increase of output. Therefore, in cases where the flyback transistor is used in a high-power power supply circuit, a flyback transformer whose current capacity is relatively large is preferably used.

In contrast, in this second embodiment, when the main switching element 31 is off, the sub switching element 32 is already off, and therefore no current flows in the flyback transformer 34. This may reduce the load to the flyback transformer 34.

As a result, the flyback transformer 34 of this embodiment may be smaller than the flyback transformer 34 of the first embodiment. Generally, a large area is used for placement of a transformer. If a smaller flyback transformer is achieved, this has an advantage that mounting efficiency may be improved.

While the preferred embodiments of the present disclosure have been described in detail above, the present disclosure is not limited to such specific embodiments, and various modification and changes may be made without departing from the gist of the present disclosure, as claimed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A power supply apparatus comprising:
an input terminal to which alternating current power is input;
a positive terminal and a negative terminal at which direct-current power is output;
a rectifier circuit configured to rectify the alternating current power input to the input terminal;
an inductor coupled to the rectifier circuit;
a capacitor coupled between the positive terminal and the negative terminal;
a first rectifying element coupled between an output terminal of the inductor and the positive terminal, the first rectifying element having a rectifying direction from the output terminal of the inductor toward the positive terminal;
a first switching element coupled between an input terminal of the first rectifying element and the negative terminal;
a second switching element and a transformer coupled in parallel to the first switching element;
a second rectifying element coupled between the positive terminal and a coupling portion of the second switching element and the transformer, the second rectifying element having a rectification direction from the coupling portion toward the positive terminal; and
a third rectifying element coupled between the transformer and the positive terminal, the third rectifying element having a rectifying direction from the transformer toward the positive terminal.

2. The power supply apparatus according to claim 1, further comprising:
a controller configured to perform PWM control of a gate of the first switching element.

3. The power supply apparatus according to claim 2,
wherein the controller turns on a gate of the second switching element before turning on the gate of the first switching element.

4. The power supply apparatus according to claim 1,
wherein the first switching element is a GaN-HEMT.

5. The power supply apparatus according to claim 1,
wherein the first switching element has a parasitic capacitance between a source and a drain of the first switching element.

6. The power supply apparatus according to claim 1,
wherein the transformer is coupled to a source of the second switching element.

7. The power supply apparatus according to claim 6,
wherein the transformer is a flyback transformer whose primary side and secondary side are opposite in phase.

8. The power supply apparatus according to claim 1,
wherein the transformer is coupled to a drain of the second switching element.
